(19) United States
(12) Patent Application Publication
(10) Pub. No.: US 2022/0269317 A1
(43) Pub. Date: Aug. 25, 2022

(54) ELECTRONIC APPARATUS

(71) Applicant: Lenovo (Singapore) Pte. Ltd., Singapore (SG)

(72) Inventors: Kenji Watamura, Kanagawa (JP); Yuichi Onda, Kanagawa (JP); Seita Horikoshi, Kanagawa (JP)

(73) Assignee: Lenovo (Singapore) Pte. Ltd., Singapore (SG)

(21) Appl. No.: 17/579,105

(22) Filed: Jan. 19, 2022

(30) Foreign Application Priority Data
Feb. 24, 2021 (JP) 2021-027501

(51) Int. Cl. G06F 1/16

(52) U.S. Cl. CPC G06F 1/1681

(57) ABSTRACT

An electronic apparatus includes: a first chassis having a keyboard mounted thereon; a second chassis having a display mounted thereon; a first hinge that connects the first chassis with the second chassis in a rotatable manner and that has a torque mechanism section; a third chassis that is adjacent to end portions of the first chassis and the second chassis; a second hinge that connects the third chassis to the first chassis in a rotatable manner; and a traction member including: a first end portion fixed to the second chassis, and a second end portion fixed to the third chassis. The traction member causes the third chassis to be pulled by the second chassis when the first chassis and the second chassis rotate from the first angle attitude toward the 0-degree attitude.

### CROSS-REFERENCE TO RELATED APPLICATIONS

This application claims priority to Japanese Patent Application No. 2021-027501 filed Feb. 24, 2021, the contents of which are incorporated herein by reference in their entirety.

### TECHNICAL FIELD

The present disclosure relates to an electronic apparatus in which a plurality of chassis are connected.

### BACKGROUND

A laptop computer typically includes a keyboard chassis connected to a display chassis through a hinge mechanism. In particular, the hinge mechanism is subject to room for improvement.

### SUMMARY

In one aspect, an electronic apparatus includes: a first chassis having a keyboard mounted thereon; a second chassis having a display mounted thereon; a first hinge that connects the first chassis and the second chassis in a rotatable manner, and has a torque mechanism section; a third chassis that is adjacent to end portions of the first chassis and the second chassis; a second hinge that connects the third chassis to the first chassis in a rotatable manner; and a traction member including a first end portion fixed to the second chassis and a second end portion fixed to the third chassis, the traction member being configured to cause the third chassis to be pulled by the second chassis when the first chassis and the second chassis rotate from the first angle attitude toward the 0-degree attitude.

### BRIEF DESCRIPTION OF THE DRAWINGS

FIG. 1 is a perspective view of an electronic apparatus according to an embodiment;

FIG. 2 is a perspective view of a state in which a first chassis and a second chassis have been closed to set a 0-degree attitude;

FIG. 3A is an enlarged schematic side view of a connection section and its surrounding parts of each chassis at the 0-degree attitude;

FIG. 3B is an enlarged schematic side view of the connection section and its surrounding parts of each chassis at a 135-degree attitude;

FIG. 3C is an enlarged schematic side view of the connection section and its surrounding parts of each chassis at the 180-degree attitude;

FIG. 4A is an enlarged schematic side sectional view of the connection section and its surrounding parts of each chassis at the 0-degree attitude;

FIG. 4B is an enlarged schematic side sectional view of the connection section and its surrounding parts of each chassis at the 135-degree attitude;

FIG. 4C is an enlarged schematic side sectional view of the connection section and its surrounding parts of each chassis at the 180-degree attitude;

FIG. 5 is a perspective view of the connection section and its surrounding parts of each chassis at the 0-degree attitude observed from below;

FIG. 6A is a schematic side sectional view of the electronic apparatus at the 0-degree attitude cut at a position intersecting with a traction member;

FIG. 6B is a schematic side sectional view of the electronic apparatus, which is illustrated in FIG. 6A, set at the 135-degree attitude; and

FIG. 7 is a perspective view of the connection section and its surrounding parts of each chassis at the 0-degree attitude observed from above.

### DETAILED DESCRIPTION

The following will describe in detail an electronic apparatus according to embodiments of the present disclosure with reference to the accompanying drawings.

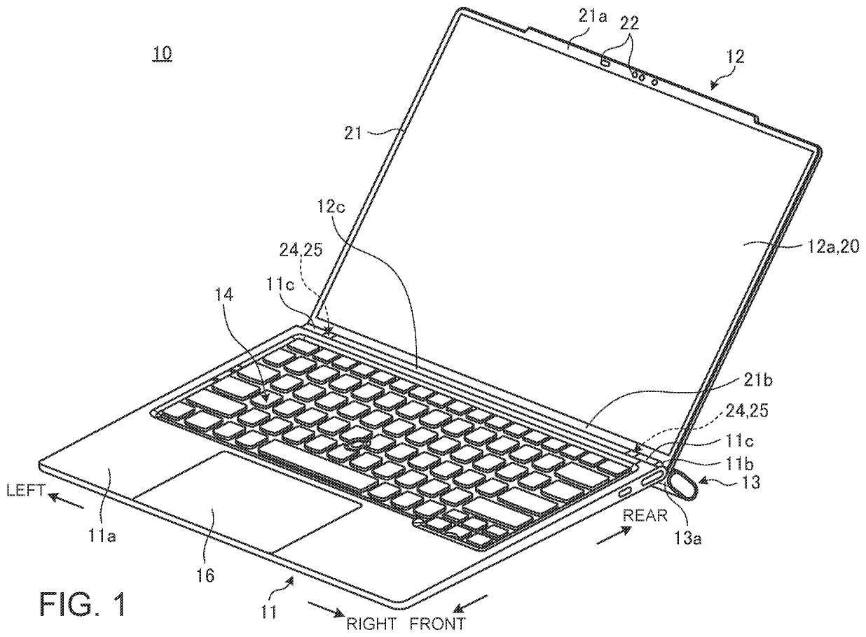

FIG. 1 is a perspective view of an electronic apparatus 10 according to an embodiment. As illustrated in FIG. 1, the electronic apparatus 10 includes a first chassis 11, a second chassis 12, and a third chassis 13. The second chassis 12 and the third chassis 13 are connected to the first chassis 11 in a rotatable manner. In the electronic apparatus 10, the first chassis 11 and the second chassis 12 constitute the exterior of a typical clamshell laptop PC, and the third chassis 13 functions as a device housing and a stand of the laptop PC.

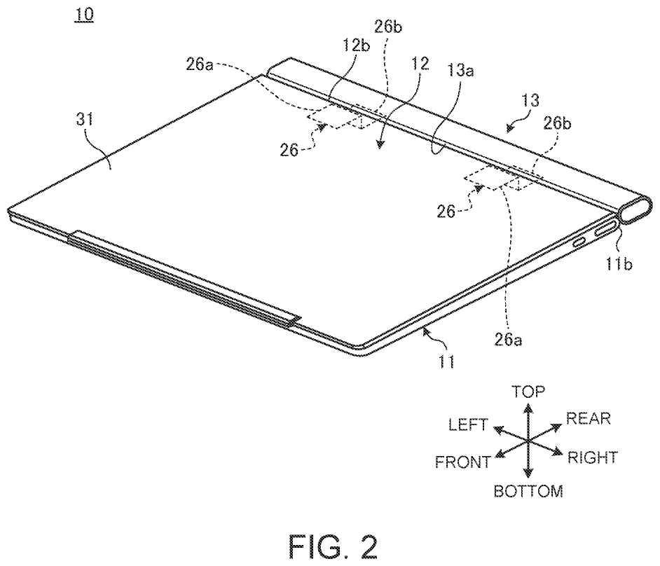

FIG. 2 is a perspective view illustrating a state in which the first chassis 11 and the second chassis 12 have been closed to set a 0-degree attitude. In the following description of the electronic apparatus 10, unless otherwise explained, the depth direction of each of the chassis 11 to 13 will be referred to as a front-rear direction, the width direction as a left-right direction, and the thickness direction as a top-bottom direction at the 0-degree attitude illustrated in FIG. 2. These directions are for convenience of description, and the actual directions vary depending on the attitude of the electronic apparatus 10 while being used or housed, or depending on a viewing direction.

First, the overall configuration of each of the chassis 11 to 13 will be described.

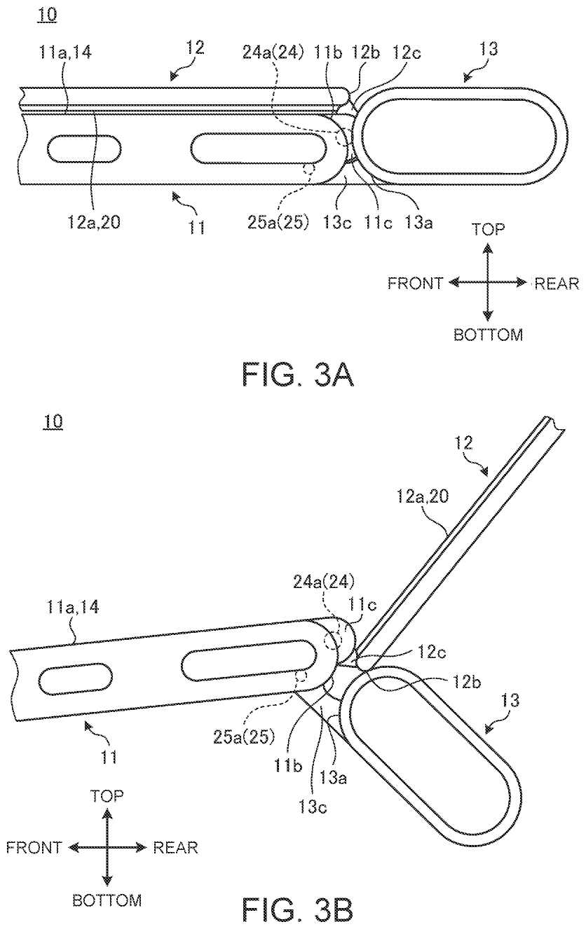

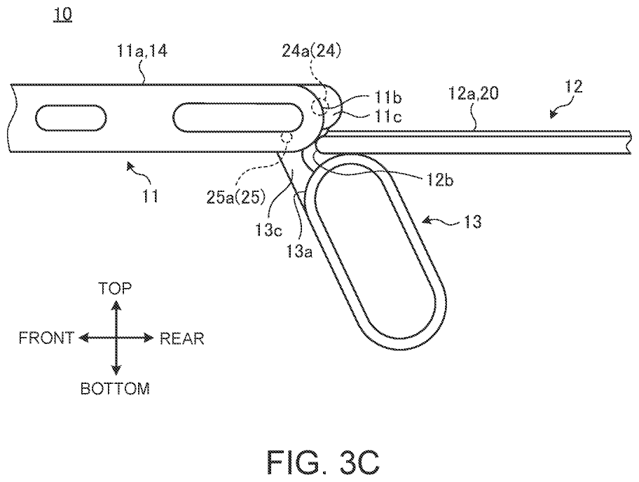

FIG. 3A, FIG. 3B, and FIG. 3C are enlarged schematic side views of the connection section and its surrounding parts of each of the chassis 11 to 13 at a 0-degree attitude, a 135-degree attitude, and a 180-degree attitude, respectively. The first chassis 11 and the second chassis 12 can be rotated relative to each other from the 0-degree attitude, at which these two chassis are placed to overlap each other in a surface normal direction (refer to FIG. 2 and FIG. 3A), to a 180-degree attitude, at which the two chassis are placed side by side in a direction perpendicular to the surface normal directions thereof into a flat plate shape (refer to FIG. 3C) via a 90-degree attitude, at which the surface normal directions of the two chassis are orthogonal to each other. The third chassis 13 is relatively rotated with respect to the first chassis 11 by being pushed or pulled by the second chassis 12, which is rotated with respect to the first chassis 11. FIG. 1 and FIG. 3B illustrate a state in which the attitude angle between the first chassis 11 and the second chassis 12 has been set to 135 degrees. In this case, the angle between the second chassis 12 and the third chassis 13 is, for example 105 degrees, and the angle between the first chassis 11 and the third chassis 13 is, for example, 120 degrees.

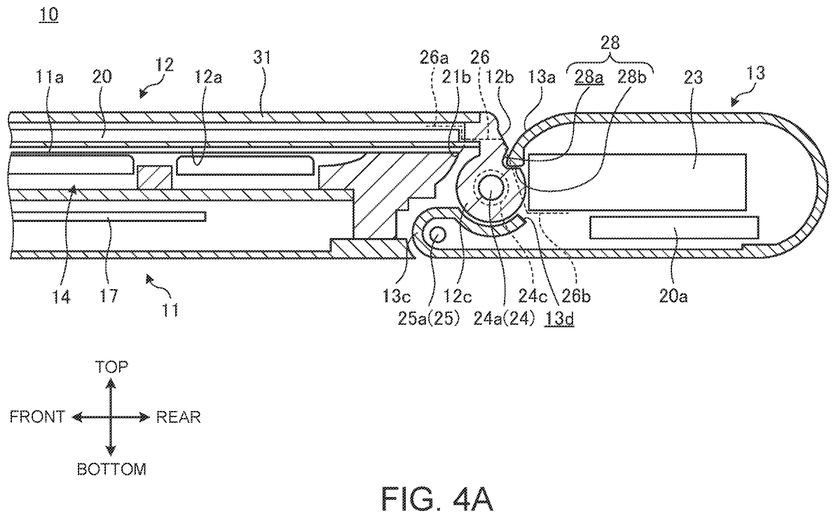

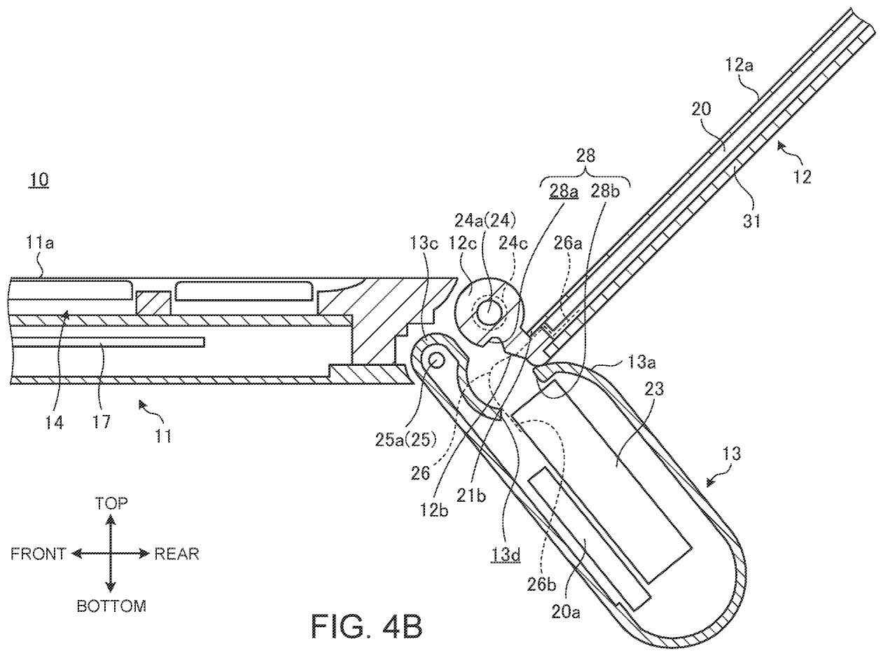

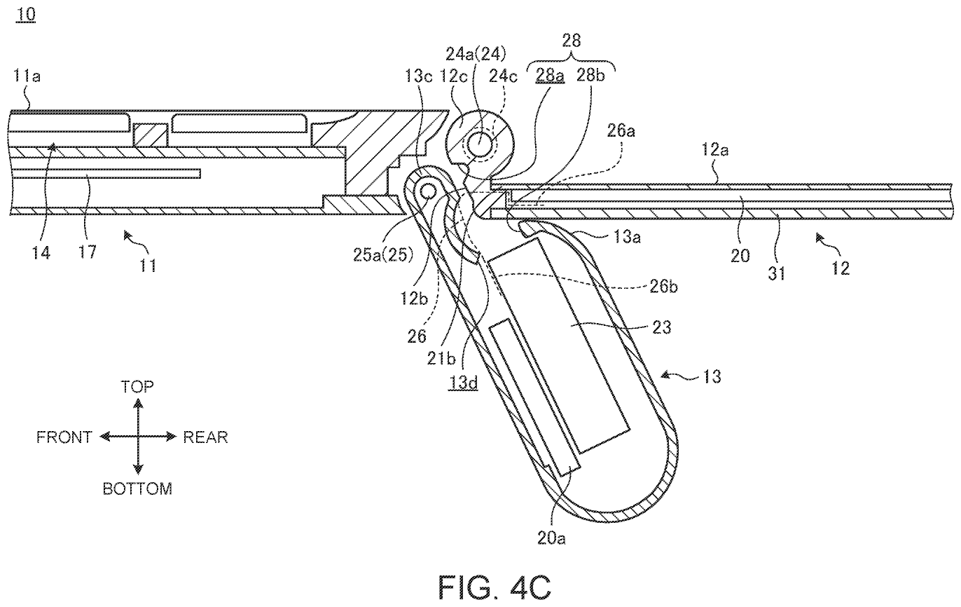

The first chassis 11 is a thin box-shaped chassis. A keyboard device 14 and a touch pad 16 are exposed on a surface 11a (the top surface when at the 0-degree attitude) of the first chassis 11. The first chassis 11 may have a touch-panel display on the surface 11a, and a software-based keyboard device may be displayed on the touch-panel display. The first chassis 11 includes therein a motherboard 17 with a CPU and memories mounted thereon (refer to FIG. 4A), a battery device, and the like.

The second chassis 12 is a chassis shaped like a box that is thinner than the first chassis 11. A display 20 is exposed on a surface 12a (the bottom surface when at the 0-degree attitude) of the second chassis 12. The display 20 is, for example, a liquid crystal display or an organic EL display, and the display thereof is controlled by a control board 20a (refer to FIG. 4A). The periphery of the display 20 is surrounded by a frame-shaped bezel 21. Of the four sides of the bezel 21, a part positioned on the upper side (a top bezel 21a) at the angle attitude illustrated in FIG. 1 is provided with subdevices 22, such as a camera, a microphone, and the like. A cover glass that covers the surface 12a of the second chassis 12 may serve as the bezel 21.

The third chassis 13 is a chassis shaped like a box that is thicker than the chassis 11 and 12, and has a smaller dimension in the front-rear direction. The plate thickness of the third chassis 13 is, for example, substantially the same as the total value of the plate thicknesses of the chassis 11 and 12 (refer to FIG. 3A). At the 0-degree attitude, the third chassis 13 takes an attitude protruding to the rear from rear end portions 11b and 12b of the chassis 11 and 12, respectively. The third chassis 13 has two major functions. The first function is a function as a device housing that houses the control board 20a of the display 20, a speaker 23, an antenna, and the like. The second function is a function as a stand when using the electronic apparatus 10 by opening the second chassis 12 from the first chassis 11.

A description will now be given of the specific configurations of the connection section and its surrounding parts of each of the chassis 11 to 13.

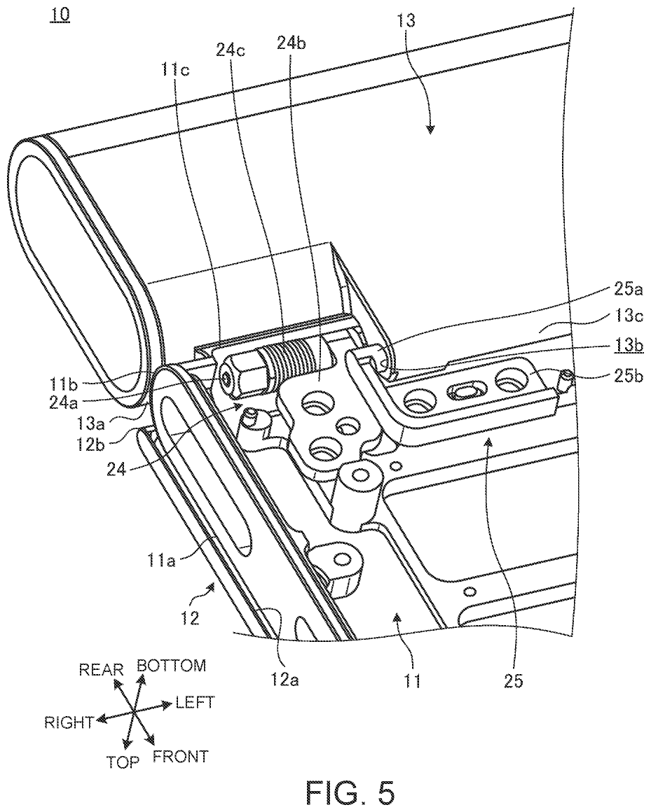

FIG. 4A, FIG. 4B, and FIG. 4C are enlarged schematic side sectional views of the connection section and its surrounding parts of each of the chassis 11 to 13 at the 0-degree attitude, the 135-degree attitude, and the 180-degree attitude, respectively. FIG. 4A to FIG. 4C schematically illustrate the structures of the chassis 11 to 13 cut at the positions intersecting with hinges 24 and 25. FIG. 5 is a perspective view that illustrates the connection section and its surrounding parts of each of the chassis 11 to 13 at the 0-degree attitude observed from front obliquely below, and schematically illustrates the internal structure of the first chassis 11, with a cover member, which constitutes the bottom surface of the first chassis 11, removed.

As illustrated in FIG. 4A to FIG. 5, the first chassis 11 and the second chassis 12 have the rear end portions 11b and 12b thereof connected in a rotatable manner by using first hinges 24. The first chassis 11 and the third chassis 13 have the rear end portion 11b and a front end portion 13a thereof connected in a rotatable manner by using second hinges 25. Although the second chassis 12 and the third chassis 13 are not directly connected by hinges, traction members 26, a wiring member 27, and the like extend therebetween.

As illustrated in FIG. 4A to FIG. 5, the first hinge 24 has a first hinge shaft 24a, a first bracket 24b, and a torque mechanism section 24c. The first hinge 24 of the present embodiment is installed as a pair on the left and right (refer to FIG. 1), and has a structure that is laterally symmetrical to each other.

The first hinge shaft 24a is a metal shaft serving as the shaft of rotation between the chassis 11 and 12. The first bracket 24b is a metal plate for attaching the first hinge 24 to the first chassis 11, and is fixed to the first chassis 11. The torque mechanism section 24c is a mechanism that imparts predetermined rotational torque to the rotation between the chassis 11 and 12 by the first hinge 24.

The first hinge shaft 24a has one end portion thereof unrotatably fitted to a bearing of the second chassis 12 and the other end portion thereof inserted in a bearing of the first bracket 24b in a rotatable manner. Further, the other end portion of the first hinge shaft 24a is inserted in the torque mechanism section 24c. The torque mechanism section 24c is composed of, for example, a plurality of metal discs, through which the first hinge shaft 24a passes, stacked in the axial direction of the first hinge shaft 24a, and is configured to impart predetermined rotational torque between the first hinge shaft 24a and the first bracket 24b by the sliding friction between the discs. Thus, the torque mechanism section 24c imparts the predetermined rotational torque to the relative rotation between the first hinge shaft 24a and the first bracket 24b, that is, the predetermined rotational torque is imparted by the torque mechanism section 24c to the relative rotation between the chassis 11 and 12.

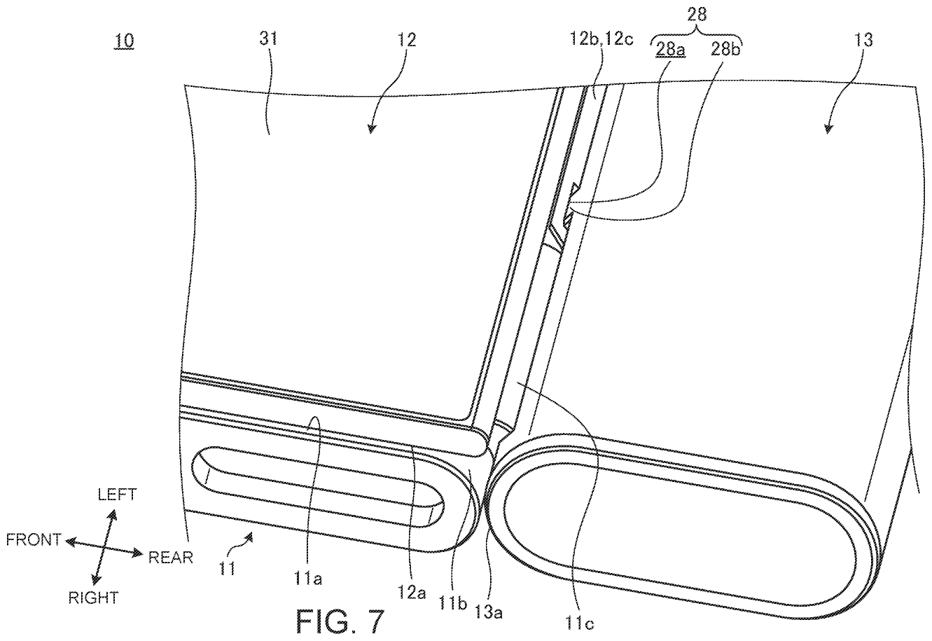

As illustrated in FIG. 3A, FIG. 3B, and FIG. 5, semi-cylindrical protrusions 11c are provided at both left and right ends of the rear end portion 11b of the first chassis 11 (refer also to FIG. 1). Each of the protrusions 11c is a portion protruding rearward relative to the central portion of the rear end portion 11b. A jaw-shaped hinge chassis 12c provided at the rear end portion 12b of the second chassis 12 is inserted into the gap between the left and right protrusions 11c and 11c in a relatively movable manner (refer also to FIG. 7). The hinge chassis 12c projects from a surface 12a of the second chassis 12 in a substantially L shape so as to be orthogonal thereto.

In each of the first hinges 24, the first hinge shaft 24a and the torque mechanism section 24c are installed to each of the protrusions 11c. The first hinge shaft 24a passes through the inward-facing side end surfaces of the protrusions 11c, and is inserted into the hinge chassis 12c and fixed. Thus, the first hinges 24 connect the first chassis 11 and the second chassis 12.

As illustrated in FIG. 4A to FIG. 5, the second hinge 25 has a second hinge shaft 25a and a second bracket 25b. The second hinge 25 is installed in a pair on the left and right (refer to FIG. 1) to be laterally symmetrical to each other.

The second hinge shaft 25a is a metal shaft serving as the shaft of rotation between the chassis 11 and 13. The second bracket 25b is a metal plate for attaching the second hinge 25 to the first chassis 11, and is fixed to the first chassis 11.

In the second hinge 25, the second hinge shaft 25a and the second bracket 25b are integrally formed. One end of the second hinge shaft 25a is inserted into a bearing 13b of the third chassis 13 in a rotatable manner (refer to FIG. 5). The other end of the second hinge shaft 25a is integral with the second bracket 25b.

Unlike the first hinge 24, the second hinge 25 does not have an intentional torque mechanism section for generating rotational torque for the rotation between the chassis 11 and 13, that is, a mechanical or structural mechanism for generating torque. Consequently, relative rotation is performed between the second hinge shaft 25a and the bearing 13b of the third chassis 13 with substantially no rotational torque. As a result, as is clear from FIG. 5, the second hinge 25 is simpler and smaller in structure than the first hinge 24 having the torque mechanism section 24c.

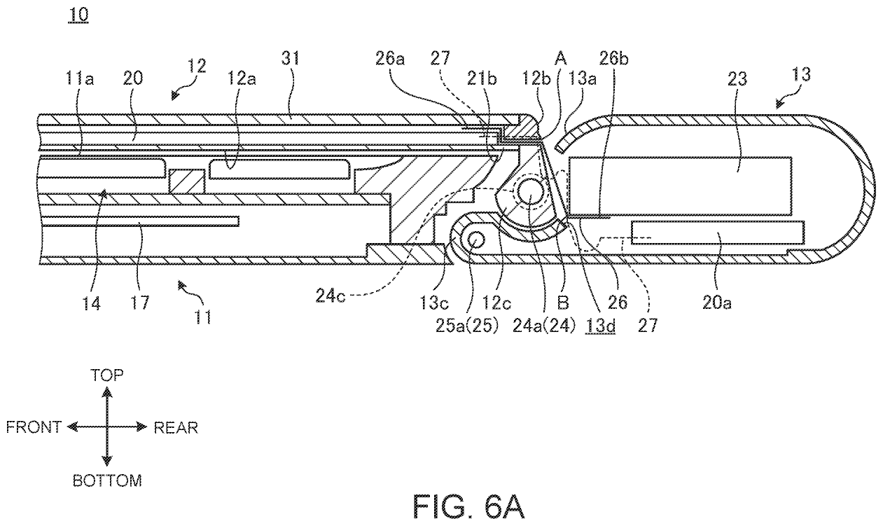

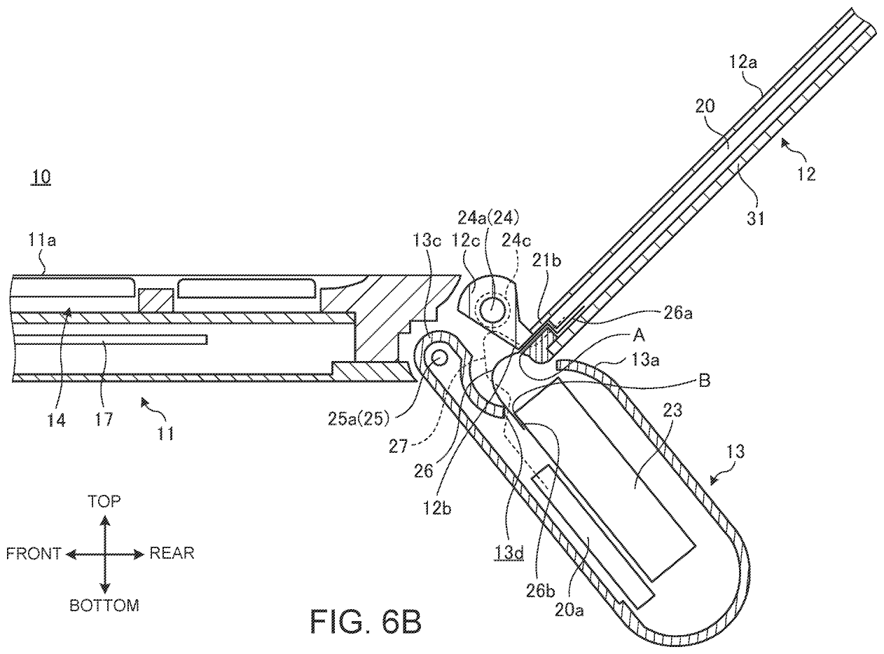

However, when the second chassis 12 is opened, if the traction member 26 is flexed as described below (refer to, for example, FIG. 6B), the third chassis 13 may develop backlash corresponding to the amount of the flexion. Therefore, when the electronic apparatus 10 is lifted with the second chassis 12 open to a certain extent or more, the third chassis 13 inconveniently moves by the amount of the backlash. In this regard, in an actual product, rotational torque due to the sliding friction between members may naturally occur between the second hinge shaft 25a and the bearing 13b. The rotational torque due to the sliding friction is extremely small, as compared with the torque generated by the torque mechanism section 24c of the first hinge 24. However, effects such as the rotational torque due to the sliding friction and the resistance due to the wiring laid between the third chassis 13 and the chassis 11, 12 suppress the occurrence of an excessive free backlash of the third chassis 13 that impairs the product quality. Further, a lubricant such as damper grease may be applied to the outer peripheral surface of the second hinge shaft 25a to impart a minute rotational torque to the rotation of the second hinge shaft 25a. This makes it possible to further suppress the backlash of the third chassis 13. As a matter of course, the grease does not adversely affect the simplification and downsizing of the structure of the second hinge 25.

As illustrated in FIG. 3A to FIG. 5, a front end portion 13a of the third chassis 13 is provided with an arm portion 13c shaped substantially like a boomerang protruding forward in a side view. The bearing 13b (the second hinge shaft 25a) is placed at the tip of the arm portion 13c. The arm portion 13c functions as an arm for connecting the third chassis 13 to the first chassis 11, and further functions also as a hinge chassis of the second hinge 25. The arm portion 13c is provided at a position where the arm portion 13c vertically overlaps the hinge chassis 12c of the second chassis 12, and protrudes forward from the left and right end portions of the front end portion 13a. The arm portion 13c is inserted into the gap between the left and right protrusions 11c and 11c of the first chassis 11 in a relatively movable manner (refer to FIG. 5).

In each of the second hinges 25, the second hinge shaft 25a is installed in the vicinity of the protrusion 11c. The second hinge shaft 25a passes the inward-facing side end surface of the protrusion 11c, and is inserted into the arm portion 13c and supported by the bearing 13b. Thus, the second hinges 25 connect the first chassis 11 and the third chassis 13 in a rotatable manner.

As described above, the arm portion 13c of the third chassis 13 vertically overlaps the hinge chassis 12c of the second chassis 12. Here, as illustrated in FIG. 4A, the axial center of the second hinge shaft 25a is placed at a position where the axial center is on the front side in a front-rear direction of the first chassis 11 and on the bottom side in the top-bottom direction of the first chassis 11 with respect to the axial center of the first hinge shaft 24a.

As described above, the second hinges 25 do not have torque mechanism sections. Therefore, the third chassis 13 rotates without rotational torque with respect to the first chassis 11, and moves relative to the second chassis 12 in such a manner as to turn without rotational torque. Consequently, the electronic apparatus 10 has the traction members 26 and a lock section 28 between the second chassis 12 and the third chassis 13.

FIG. 6A is a schematic side sectional view of the electronic apparatus 10 at the 0-degree attitude cut at a position intersecting with the traction member 26. FIG. 6B is a schematic side sectional view of the electronic apparatus 10, which is illustrated in FIG. 6A, set at the 135-degree attitude. FIG. 7 is a perspective view of the connection section and its surrounding parts of each of the chassis 11 to 13 set at the 0-degree attitude observed from rear obliquely above.

As illustrated in FIG. 6A and FIG. 6B, the traction members 26 are sheet-like or wire-like members extending between the second chassis 12 and the third chassis 13. The traction members 26 in the present embodiment are thin, flexible belt-shaped sheet members formed of a metal such as stainless steel, and provided, for example, in a pair on the left and right (refer to FIG. 2). The traction members 26 are members that have substantially no stretchability. The traction members 26 may be members having stretchability. In this case, however, the traction members 26 preferably stretch fully at an angle (e.g., 40-degree attitude) between the 90-degree attitude and the 0-degree attitude when the second chassis 12 is rotated with respect to the first chassis 11 in the direction toward the 0-degree attitude from the 135-degree attitude. This enables the third chassis 13 to be smoothly pulled by the second chassis 12 even with the traction members 26 having stretchability. Further, the traction members 26 having stretchability fully stretch at an angle greater than zero degrees (e.g., the 40-degree attitude mentioned above), so that the reaction force generated when the traction members 26 contract will act between the chassis 12 and 13 during the rotation toward the zero degrees via 40 degrees. Hence, after 40 degrees, the rotation of the third chassis 13 to zero degrees will be even smoother. In addition, the traction members 26 provide an effect of pulling the third chassis 13 toward the second chassis 12 at the 0-degree attitude, thus stabilizing the attitude of the third chassis 13.

A first end portion 26a of each of the traction members 26 is inserted into the second chassis 12 through a rearward-facing opening formed in a rear end portion 12b (the hinge chassis 12c) of the second chassis 12, and is fixed to, for example, a rear cover member 31 of the second chassis 12 with an adhesive or the like. A second end portion 26b of the traction member 26 is inserted into the third chassis 13 through a forward-facing opening 13d formed in a front end portion 13a of the third chassis 13, and is fixed to, for example, the speaker 23 with an adhesive or the like. Thus, the traction members 26 connect the chassis 12 and 13, with the first end portions 26a fixed to the second chassis 12 and the second end portions 26b fixed to the third chassis 13.

The wiring member 27 that electrically connects the display 20 and the control board 20a also passes through the opening 13d and extends between the chassis 12 and 13. The wiring member 27 is, for example, a flexible printed circuit board (FPC). Further, a wiring member from the subdevices 22 to the motherboard 17 also extends from the second chassis 12 to the first chassis 11 via the third chassis 13. The wiring member 27 and the like are installed side by side approximately, for example, one to three in the left-right direction, and some of them may be stacked with the traction members 26. The length of the wiring member 27 is set to have a margin such that the wiring member 27 always has an extra length and is in a flexed (i.e., sagging) state regardless of the angle attitude between the chassis 11 and 12 (refer to FIG. 6A and FIG. 6B). This is to prevent the wiring member 27 from being damaged by excessive bending force when the chassis 12 and 13 are rotated relative to each other. The wiring from the control board 20a and the speaker 23 to the motherboard 17 also passes through the opening 13d and extends between the chassis 11 and 13.

At the 0-degree attitude illustrated in FIG. 6A, the traction members 26 are in a slightly loosened state. At an angle attitude (e.g., the 40-degree attitude) between the 0-degree attitude and the 90-degree attitude, the traction members 26 are in a tensioned state in which the traction members 26 are subjected to a tensile force between the chassis 12 and 13 and fully stretched with no flexure. At the 135-degree attitude illustrated in FIG. 6B, the traction members 26 are not subjected to the tensile force between the chassis 12 and 13 and are in a loosened state with flexure. At the 180-degree attitude also, the traction members 26 are flexed between the chassis 12 and 13 to approximately the same extent as at the 135-degree attitude, or are flexed to some extent although the traction members 26 are pulled somewhat more than at the 135-degree attitude (refer to the traction member 26 indicated by the dashed line in FIG. 4C). Consequently, when the chassis 11 and 12 are closed from the 180-degree attitude to the 0-degree attitude, the traction members 26 are initially loose but become tense in the middle (e.g., at the 40-degree attitude mentioned above). As a result, after the traction members 26 become tense, the second chassis 12 pulls the third chassis 13 up to the attitude illustrated in FIG. 6A.

As illustrated in FIG. 4A to FIG. 4C and FIG. 7, the lock section 28 is composed of a recessed portion 28a and a protruding portion 28b formed to be engageable with and disengageable from the recessed portion 28a. The recessed portion 28a is a portion of the rear end portion 12b of the second chassis 12, the portion being located at the hinge chassis 12c and being recessed forward. The protruding portion 28b is formed at the front end portion 13a of the third chassis 13, and is provided at, for example, an upper edge portion of the opening 13d. The lock section 28 may have the recessed portion 28a provided in the third chassis 13 and the protruding portion 28b in the second chassis 12.

At the 0-degree attitude illustrated in FIG. 4A, the lock section 28 is in a state in which the protruding portion 28b engages with the recessed portion 28a, thus locking the relative movement of the third chassis 13 with respect to the chassis 11 and 12. Specifically, with the lock section 28 in the engaged state, the third chassis 13 is locked to the second chassis 12, thereby restricting the rotation of the third chassis 13 with respect to the first chassis 11 by the second hinge 25. At the 135-degree attitude and the 180-degree attitude illustrated in FIG. 4B and FIG. 4C, respectively, the lock section 28 is in a disengaged state in which the protruding portion 28b is separated from the recessed portion 28a, thus allowing the third chassis 13 to relatively move with respect to the chassis 11 and 12. In other words, in the electronic apparatus 10, the second hinge 25 does not have a torque mechanism section. Therefore, in the electronic apparatus 10, the third chassis 13 is locked to the second chassis 12 through the lock section 28 at the 0-degree attitude, thereby restricting the third chassis 13 from developing backlash or unexpectedly rotating.

A description will now be given of the operation and working effects of the electronic apparatus 10.

First, the state in which the chassis 11 and 12 are at the 0-degree attitude as illustrated in FIG. 4A will be described. In this state, the surfaces 11a and 12a of the chassis 11 and 12, respectively, face each other, that is, the keyboard device 14 and the display 20 face each other. The third chassis 13 is at an attitude of protruding rearward from the rear end portions 11b and 12b of the chassis 11 and 12, respectively. As illustrated in FIG. 3A and FIG. 4A, the thickness of the third chassis 13 is set to be the same as or substantially the same as the total value obtained by adding the thickness of the first chassis 11 and the thickness of the second chassis 12.

Therefore, at the 0-degree attitude, the electronic apparatus 10 is as thin as a typical laptop PC, and transformed into a substantially single plate (refer also to FIG. 2). The third chassis 13 can easily accommodate a speaker, particularly a large-volume component such as a woofer, together with the control board 20a by utilizing a thickness larger than those of the other chassis 11 and 12. As a result, the first chassis 11 does not need to accommodate the speaker 23 and the like, or at least does not need a space for installing a thick component such as a woofer, and can be made thinner accordingly. Of the speaker components, a woofer in particular is difficult to make thinner and can be a limitation in determining the thickness of the first chassis 11, so that the fact that the woofer can be installed in the third chassis 13 makes it easier to reduce the thickness of the first chassis 11. Further, the second chassis 12 does not need the control board 20a, which was conventionally placed on the rear side of the display 20, and can be therefore made thinner accordingly.

The 0-degree attitude is the attitude used when carrying the electronic apparatus 10. In the electronic apparatus 10 of the present embodiment, the second hinge 25 connecting the third chassis 13 to the first chassis 11 does not have a torque mechanism section. Therefore, if a user grasps, for example, the third chassis 13 at the rear end with his/her hand when carrying the electronic apparatus 10, then there is a concern that the chassis 11 and 12 on the front side will be folded downward from the second hinge shaft 25a due to their own weights. Further, if the user grasps, for example, the front ends of the chassis 11 and 12 with his/her hand, then there is a concern that the third chassis 13 on the rear side will be folded downward from the second hinge shaft 25a due to its own weight.

Therefore, the electronic apparatus 10 includes the lock section 28 to lock the third chassis 13 with respect to the chassis 11 and 12 at the 0-degree attitude. This enables the electronic apparatus 10 to avoid the problem of the chassis 11, 12 or 13 being folded downward when carrying the electronic apparatus 10, as described above, and the angles of the chassis 11 to 13 are stably maintained.

A description will now be given of the operation of opening the chassis 11 and 12 from the 0-degree attitude toward the 180-degree attitude. In this opening operation, as in the case of a typical clamshell laptop PC, the front of the second chassis 12 is raised from the first chassis 11 in a state in which, for example, the electronic apparatus 10 is placed on a desk or the like. Then, as illustrated in FIG. 4A and FIG. 4B, the second chassis 12 rotates with respect to the first chassis 11, with the first hinge shaft 24a serving as the rotation shaft. This rotational movement is performed under the torque imparted by the torque mechanism section 24c, thus making it possible to maintain the second chassis 12 at a desired angle attitude with respect to the first chassis 11. Although the second hinge 25 has a torque-free structure, the second hinge 25 is not involved in maintaining an angle between the first chassis 11 and the second chassis 12.

Here, the hinge chassis 12c protrudes from the rear end portion 12b of the second chassis 12, and the first hinge shaft 24a is located at the tip end of the hinge chassis 12c. In other words, the first hinge 24 is a so-called drop-down hinge. Consequently, as illustrated in FIG. 4B, the second chassis 12 moves to a position where the rear end portion 12b is hidden behind the first chassis 11 at the 135-degree attitude and at angles in the vicinity thereof where the same usage mode as that of a typical clamshell laptop PC is expected. More specifically, in the second chassis 12, the bezel 21 (a lower bezel 21b) on the rear side of the display 20 (the lower side in FIG. 4B) moves to a level lower than the surface 11a of the first chassis 11. As a result, when the electronic apparatus 10 is in use, the lower bezel 21b is hidden by the first chassis 11 and is not noticeable, thus providing high appearance quality.

At this time, the axial center of the second hinge shaft 25a is located at a position on the front side and lower with respect to the axial center of the first hinge shaft 24a. Consequently, as illustrated in FIG. 4A and FIG. 4B, when the hinge chassis 12c rotates during the opening operation, first, the recessed portion 28a causes the third chassis 13 to rotate clockwise in the drawing, with the second hinge shaft 25a serving as the rotation shaft, while pushing the protruding portion 28b down. Then, the rear end portion 12b of the second chassis 12, which rotates, slides while pressing the front end portion 13a of the third chassis 13, the front end portion 13a being formed to have a curved surface. In the case of the present embodiment, the second hinge shaft 25a is torque-free. Therefore, as illustrated in FIG. 4B, the third chassis 13 easily rotates by receiving the pressing force from the rear end portion 12b of the second chassis 12, and moves, hanging down from the bottom surface of the first chassis 11. In the lock section 28, when, for example, the second chassis 12 is opened to approximately 40 to 45 degrees with respect to the first chassis 11, the protruding portion 28b starts to disengage from the recessed portion 28a, and the engaged state is released.

As illustrated in FIG. 3B and FIG. 4B, at the 135-degree attitude, the third chassis 13 is set at an angle attitude of approximately 120 degrees with respect to the first chassis 11 and approximately 105 degrees with respect to the second chassis 12. Consequently, the electronic apparatus 10 is set at an attitude where the rear end portion 11b of the first chassis 11 is raised somewhat upward by the third chassis 13 on a desk or the like (refer to FIG. 3B). As a result, the third chassis 13 functions as a stand for the electronic apparatus 10, and the first chassis 11 is set at an appropriate angle attitude, with the front thereof down, thus improving the ease of use of the keyboard device 14.

The opening operation from the 135-degree attitude to the 180-degree attitude is the same as the opening operation from the 0-degree attitude to the 135-degree attitude. More specifically, as illustrated in FIG. 4B and FIG. 4C, the rear end portion 12b of the second chassis 12, which rotates, slides while further pressing the front end portion 13a of the third chassis 13. As a result, at the 180-degree attitude illustrated in FIG. 4C, the surfaces 11a and 12a of the first chassis 11 and the second chassis 12, respectively, become substantially parallel, and the third chassis 13 rotates further clockwise from the 135-degree attitude and stops at this position. The third chassis 13 does not rotate further clockwise from the attitude illustrated in FIG. 4C because the traction members 26 are tensioned or there is a stopper between the third chassis 13 and the first chassis 11.

Next, in the closing operation to the 0-degree attitude from the 180-degree attitude, the front of the second chassis 12 is grasped, raised and rotated from the state illustrated in FIG. 4C. This causes the second chassis 12 to rotate in the opposite direction from that in the opening operation, and the rear end portion 12b moves away from the front end portion 13a of the third chassis 13. Consequently, the traction members 26, which are in a flexed and loose state at the 180-degree attitude or the 135-degree attitude, gradually lose the amount of the flexion toward the 0-degree attitude.

Then, when the attitude passes, for example, the 90-degree attitude and reaches, for example, the 40-degree attitude mentioned above, the traction members 26 are subjected to the tensile force between the chassis 12 and 13 and set to the tensioned state. Consequently, as the second chassis 12 closes, the third chassis 13 is pulled up by the traction members 26 toward the position of the 0-degree attitude. Here, in the lock section 28, the protruding portion 28b starts to engage with the recessed portion 28a when, for example, the second chassis 12 reaches approximately 45 to 40 degrees with respect to the first chassis 11 and the third chassis 13 reaches approximately 18 degrees with respect to the first chassis 11. As a result, at the 0-degree attitude, the third chassis 13 returns to the attitude parallel to the chassis 11 and 12 again, and the lock section 28 also returns to the engaged state. At this time, the second hinge 25 is torque-free, thus requiring only a minimum amount of a force for pulling up the third chassis 13 by the traction members 26. Further, in the state in which the electronic apparatus 10 is placed on a desk or the like, the third chassis 13 gradually rotates also toward the 0-degree attitude by the self weight of the electronic apparatus 10 in the closing operation, so that the force for pulling up the third chassis 13 becomes even smaller.

In the meantime, the amount of flexion of each of the traction members 26 is determined by the linear distance between two constraint points A and B illustrated in FIG. 6A and FIG. 6B. The constraint point A is the point closest to the third chassis 13 in the portion where the traction member 26 is constrained by the second chassis 12. The constraint point B is the point closest to the second chassis 12 in the portion where the traction member 26 is constrained by the third chassis 13. This means that, in the traction member 26, the portion sandwiched between the constraint points A and B has flexibility and is a freely movable portion.

In the electronic apparatus 10 of the present embodiment, the linear distance between the constraint points A and B is approximately, for example, 5.6 mm at the 0-degree attitude, approximately, for example, 6.2 mm, which is the maximum, at the 40-degree attitude at which the lock section 28 starts locking, approximately, for example, 4.5 mm at the 135-degree attitude, and approximately, for example, 5.3 mm at the 180-degree attitude. In other words, when the chassis 11 and 12 close, the linear distance between the constraint points A and B gradually increases beyond the 135-degree attitude and reaches the maximum at or in the vicinity of the 40-degree attitude.

Therefore, for the traction member 26, the linear distance of the portion sandwiched between the constraint points A and B should be set to equal to or less than the distance between the constraint points A and B (e.g., approximately 6.2 mm) at the 40-degree attitude. This causes the traction member 26 to be fully tensioned due to a high tensile force at least when the distance between the constraint points A and B reaches the maximum. As a result, the second chassis 12 can smoothly pull the third chassis 13 through the traction member 26 in the tensed state. At the 0-degree attitude, the linear distance between the constraint points A and B becomes smaller than that at the 40-degree attitude, so that the tension of the traction member 26 becomes smaller than that at the 40-degree attitude. However, in this state, the third chassis 13 is locked to the second chassis 12 by the lock section 28, thus suppressing the backlash of the third chassis 13 as described above. A configuration may be adopted in which the linear distance between the constraint points A and B reaches the maximum at, for example, the 0-degree attitude. In other words, the traction member 26 may be configured to be tensioned by being subjected to a highest tensile force at the 0-degree attitude.

As described above, in the electronic apparatus 10 according to the present embodiment, the second chassis 12 is connected to the first chassis 11 provided with the keyboard device 14 by using the first hinge 24 having the torque mechanism section 24c, and the third chassis 13 is connected to the first chassis 11 by using the second hinge 25. The electronic apparatus 10 includes the traction members 26 that pull the third chassis 13 by the second chassis 12 when the chassis 11 and 12 are rotated toward the 0-degree attitude from the first angle attitude (e.g., the 135-degree attitude).

Therefore, in the electronic apparatus 10, when the second chassis 12 is opened, the third chassis 13 is automatically rotated by being pushed by the rear end portion 12b of the second chassis 12. On the other hand, in the electronic apparatus 10, when closing the second chassis 12, after the second chassis 12 is closed to a second angle attitude (e.g., the 40-degree attitude), the third chassis 13 follows the rotation of the second chassis 12 through the traction members 26. As a result, in the electronic apparatus 10, even when the second hinge 25, which connects the third chassis 13 to the first chassis 11, is configured to be substantially torque-free, the rotational movement of the third chassis 13 can be secured. This enables the electronic apparatus 10 to achieve the simpler and smaller configuration of the second hinge 25. The simpler and smaller configuration of the second hinge 25 makes it possible to simplify the internal structure of the first chassis 11 in which the second hinge 25 is installed, thus permitting a further smaller and thinner exterior. In addition, the electronic apparatus 10 has the lock section 28, which locks the second chassis 12 and the third chassis 13 at the 0-degree attitude, thus making it possible to suppress an unexpected rotation of the third chassis 13 at the 0-degree attitude.

Further, in the electronic apparatus 10, each of the chassis 12 and 13 is connected to the first chassis 11 provided with the keyboard device 14. Thus, the lower bezel 21b is hidden behind the first chassis 11 when the electronic apparatus 10 is in use, and the apparent width thereof is reduced, so that high appearance quality is obtained. In addition, since the chassis 12 and 13 are connected to the first chassis 11, when the electronic apparatus 10 is used as illustrated in FIG. 4B (e.g., at the 135-degree attitude), the surface normal directions of the chassis 11 to 13 intersect at a single point, and each of the chassis provides a radially extending form at apparently substantially the same angle. Consequently, the appearance quality of the electronic apparatus 10 when viewed from the side during the use is also improved.

In the electronic apparatus 10, the second hinge shaft 25a is located in front and lower with respect to the first hinge shaft 24a. Consequently, although the two hinge shafts 24a and 25a are installed to the first chassis 11, the thickness of the first chassis 11 can be controlled to a minimum. In addition, the second hinge 25 has the simpler and smaller structure, as compared with the first hinge 24 having the torque mechanism section 24c. This makes it possible to further suppress the thickness of the first chassis 11. As described above, the electronic apparatus 10 achieves the complicated movement at the time of opening and closing due to the inclusion of the third chassis 13 by the combination of the same torque hinge (the first hinge 24) as that of a typical laptop PC and the torque-free hinge (the second hinge 25). As a result, the electronic apparatus 10 does not need to use a hinge of a complicated structure having a number of components, thus making the electronic apparatus 10 advantageous in reliability and cost.

In the electronic apparatus 10, the chassis 12 and 13 are connected by the traction members 26, so that the wiring member 27 extending between the chassis 12 and 13 can always be maintained to have an extra length. This makes it possible to prevent the wiring member 27 from being damaged by being subjected to excessive load when the chassis 11 to 13 rotate.

The present disclosure is not limited to the embodiment described above, and can of course be freely modified without departing from the gist of the present disclosure.

In the above, the configuration in which the first chassis 11 and the second chassis 12 can be rotated between the 0-degree attitude and the 180-degree attitude has been exemplified. However, if the second chassis 12 can be rotated to the first angle attitude beyond the 90-degree attitude, e.g., approximately 135-degree attitude, with respect to the first chassis 11, then the same usage form as that of a typical clamshell laptop PC can be ensured.

In the above, the lock section 28 provided with the recessed portion 28a and the protruding portion 28b has been exemplified. However, the lock section 28 may have a configuration such as one in which the third chassis 13 is locked by utilizing the attraction force of a magnet in addition to or in place of the configuration that includes the recessed portion 28a and the protruding portion 28b.

What is claimed is:

1. An electronic apparatus comprising:
a first chassis comprising a keyboard mounted thereon;
a second chassis comprising a display mounted thereon;
a first hinge connecting the first chassis with the second chassis in a rotatable manner between a 0-degree attitude at which the first chassis and the second chassis are placed to overlap each other in a surface normal direction and a first angle attitude exceeding a 90-degree attitude at which surface normal directions of the first chassis and the second chassis are orthogonal to each other, wherein the first hinge comprises a torque mechanism section that imparts predetermined rotational torque to a rotation between the first chassis and the second chassis;
a third chassis that is adjacent to end portions of the first chassis and the second chassis and that is placed at an attitude protruding from end portions of the first chassis and the second chassis at the 0-degree attitude;
a second hinge that connects the third chassis to the first chassis in a rotatable manner; and
a traction member comprising:
a first end portion fixed to the second chassis; and
a second end portion fixed to the third chassis, wherein
the traction member causes the third chassis to be pulled by the second chassis when the first chassis and the second chassis rotate from the first angle attitude toward the 0-degree attitude.

2. The electronic apparatus according to claim 1, wherein
the traction member is composed of a sheet-like member or a wire-like member,
the traction member is subjected to a tensile force between the second chassis and the third chassis in response to the first chassis and the second chassis reaching a second angle attitude at least between the 0-degree attitude and the 90-degree attitude, and
the traction member is loosened between the second chassis and the third chassis in response to the first chassis and the second chassis reaching at least the first angle attitude.

3. The electronic apparatus according to claim 1, wherein the second hinge does not comprise a torque mechanism section for generating torque for a rotation between the first chassis and the third chassis.

4. The electronic apparatus according to claim 1, further comprising:
a lock section that restricts a rotation of the third chassis by the second hinge by locking the third chassis with respect to the second chassis at the 0-degree attitude.

5. The electronic apparatus according to claim 1, wherein
the first hinge comprises a first hinge shaft serving as a shaft of rotation between the first chassis and the second chassis,
the second hinge comprises a second hinge shaft serving as a shaft of rotation between the first chassis and the third chassis, and
an axial center of the second hinge shaft is disposed on a front side in a front-rear direction of the first chassis and on a bottom side in a top-bottom direction of the first chassis with respect to an axial center of the first hinge shaft.

6. The electronic apparatus according to claim 1, further comprising:
a control board that is mounted in the third chassis and controls display of the display; and
a wiring member that extends between the second chassis and the third chassis and electrically connects the display and the control board, wherein
the wiring member is sagging with extra length when the first chassis and the second chassis are between the 0-degree attitude and the first angle attitude.
